(19) United States
(12) Patent Application Publication
(10) Pub. No.: US 2025/0249430 A1
(43) Pub. Date: Aug. 7, 2025

(54) Water filter and medium therefor

(71) Applicant: Koslow Technologies Corporation, Waterbury, CT (US)

(72) Inventors: Jules A. Koslow, Waterbury, CT (US); Benjamin M. Koslow, Waterbury, CT (US); Evan E. Koslow, Waterbury, CT (US); Andrew Lombardo, Cheshire, CT (US)

(21) Appl. No.: 19/096,706

(22) Filed: Mar. 31, 2025

Related U.S. Application Data
(63) Continuation of application No. 18/653,090, filed on May 2, 2024, now abandoned.
(60) Provisional application No. 63/499,601, filed on May 2, 2023.

(51) Int. Cl. B01J 20/28; B01D 29/11; B01D 29/35; B01D 39/18; B01D 39/20; B01J 20/18; B01J 20/20; B01J 20/30; C02F 1/00; D21H 11/18; D21H 15/10; D21H 17/00; D21H 17/68; D21H 21/20; D21H 21/22; D21H 27/08; D21J 5/00

(52) U.S. Cl. CPC B01J 20/28028; B01D 29/111; B01D 29/35; B01D 39/18; B01D 39/2055; B01J 20/18; B01J 20/20; B01J 20/3007; B01J 20/3078; C02F 1/003; D21H 11/18; D21H 15/10; D21H 17/68; D21H 17/74; D21H 21/20; D21H 21/22; D21H 27/08; D21J 5/00; B01D 2239/025; B01D 2239/0407; B01D 2239/0421; B01D 2239/0492; B01D 2239/083; B01D 2239/10; B01D 2239/1291; C02F 2307/04; C02F 2307/10

(57) ABSTRACT

A process for making a water filter having the steps of hydropulping particulate and fibrous ingredients including a quantity of fibrillated cellulose with water to create a suspension, circulating the suspension in a molding tank, submerging a mold having cavities in the circulating suspension, applying a vacuum to the cavities to draw the suspension into the cavities such that the water passes through the mold and the ingredients accumulate within the cavities to form a dewatered material, ejecting the dewatered material from the mold to create a molded object, drying and curing the molded object and capping an open end of the molded object to make a filter that flows under gravity and is naturally hydrophilic with a mean flow path (MFP) as determined by porometry of less than 5 micron and preferably less than 2 micron.

### TECHNICAL FIELD

The present disclosure relates to gravity-flow filters produced using the accretion process.

### BACKGROUND

Gravity flow filters are commonly used in consumer products to produce purified potable water. In the past, such filters have primarily been produced by loading loose granular ingredients such as activated carbon and ion-exchange resin, into a trapezoidal-shaped plastic container, or through the use of a pleated filter medium sealed into such a plastic container, or through a combination of these. A critical element of this technology is that the filter medium is either naturally hydrophilic or its pore size so large that the fluid immediately wets and penetrates the adsorbent ingredients within the filter and that water flow is not impeded by a hydrophobic reaction with the filter medium.

Such filters have suffered from two problems. The loose granular systems generally provide very limited purification and have a limited ability to meet rigorous health claims as dictated by NSF International standards. Alternatively, the pleated filters are expensive and more complex to assemble but can provide a wider range of health claims. High-performance filters utilize composite (containing fibers and active particles) filter paper that needs to be pleated to obtain a reasonably high flow rate and a reasonably high dirt-holding capacity. Such filter papers have a tight pore structure to intercept micronic heavy metal contaminants at high pH values. To meet certain health claims, the pore size of the pleated filter medium usually needs to be in the range of 1-2 microns mean flow path (MFP) when measured by capillary flow porometry. This tight micron rating greatly reduces flow rate and forces the use of pleated filter media to obtain target flow rates.

The accretive molding process is well known in the art for the production of filters. For example, Chen et al. (U.S. Pat. No. 6,712,939) describes filters produced using fibrillated fibers as a wet strength additive. However, the currently disclosed systems and methods do not need to conform to Chen's suggested process of a two-step drying and curing procedure nor is it necessary to use a thermoset or thermoplastic binder.

Matchett (U.S. Pat. No. 4,032,457) also describes an accretive process for the production of filters. In this early work, combinations of fibers and active particles are used, but this work is generally done prior to the production of precision fibrillated fibers.

Even earlier than Matchett is the work of Anderson (U.S. Pat. No. 2,539,768) where thermoset resins and fibers are formed into tubular shapes produced by an accretive process.

Yoshinobu et al. (U.S. Pat. No. 9,033,158) describes the production of filters using fibrillated fibers and an activated carbon particles having a specific size and size distribution.

Other relevant art would also include U.S. Pat. No. 4,303,472; 4,376,675; 4,389,224; 2,802,408; 4,814,033; 5,605,746; and U.S. Patent Publication 2009/0045133 A1.

### SUMMARY

What would be desirable is a low-cost and rapid method of producing high-performance gravity-flow filters where there is a potential to provide enhanced surface area (similar to pleating), maximum health claims and performance, reduced materials and labor costs, and very simple and reliable high-speed mass production.

The currently disclosed system consists of gravity-flow filters produced by the accretion process, where a slurry containing fibers, particles, and certain chemicals is formed on a shaped wire using a vacuum. This is a process similar to that used to make the ubiquitous cellulose egg carton. In such a process, a porous mold is submerged into a slurry of fiber, particles, and chemicals. Vacuum is applied to cause the solid ingredients within the slurry to accumulate upon the surface of the mold. The water passes through the porous mold form and after the mold is raised out of the slurry, the vacuum is used to further reduce the moisture content of the solids that have accreted to the surface of the mold. The withdrawal of the moisture results in the formation of a wet molded article that has limited strength until dried.

There are several alternative follow-on steps to complete the production of a filter. In some cases, the molded article is ejected from the mold and released directly to a drying process that can also be used to carry out chemical or physical reactions or create permanent wet-strength at elevated temperature. Equivalent means for ejecting the molded article will be apparent to the ordinary skilled worker. Alternatively, the molded article, still wet and soft, can be ejected to a pressing station where the article can be pressed to a denser consistency while further vacuuming excess moisture from the article. During this pressing step, the article can be perforated, die cut, or its geometry further adjusted. Following this pressing process, the article can be further ejected to a drying station or drying oven where the remaining moisture can be removed and temperature raised to the point where a wet-strength binder, such as bicomponent fibers, thermoplastic or thermoset particles or latex, or a chemical binder to form covalent bonds between fibers, can be activated to form bonds between the ingredient fibers and particles that provide permanent wet strength.

For example, the part is ejected from the forming mold using compressed air and usually transferred to the press and drying mold using such compressed air. The part is eventually ejected from the drying mold also using compressed air, but this can also be accomplished by other means well known in the prior art, i.e. using ejector pins and plates.

One of the advantages of this process is that it naturally forms a “graded-density” structure where that portion of the molded article adjacent to the forming wire is more dense and has a tighter pore structure than that portion of the molded article that is located remote from the wire surface. This graded-density structure provides depth filtration and improved dirt holding capacity compared to an isotropic filter medium. The pressing of the article after formation can adjust the degree of this anisotropic property.

Once formed, possibly pressed, dried, and cured, the resulting molded articles can be processed to release the individual filters from a supporting web. The supporting web can usually be recycled. Alternatively, the molded filters can be formed without a supporting web and emerge from the process as individualized devices. The filters can then be mounted to a supporting filter interface (often referred to as an “end cap”) using hot melt or fusion welding, as well known in the art. The result is a filter with minimal need for plastics, O-rings, and other components.

Other refinements can be included during production of these filter elements. For example, it is possible to cast a two-layer structure by first vacuuming a first slurry with a first composition, followed by molding a second layer from a second slurry with a different second composition. For a male mold, one approach is to cast an inward layer of a high-fiber and low particulate prefilter layer followed by an outward layer of filter medium with a high loading of active particulate ingredients. The structure that is molded can be a simple cone as shown in FIG. 1 or a more complex shape as shown in FIGS. 2 and 3 that provides enhanced surface area and permit the filter to fit into legacy filter products that have obstructions or geometric limitations. For a female mold, the approach would be reversed, i.e. first cast the highly active filter medium followed by an inward layer of the prefilter medium. This description assumes that the finished filter will have flow from inside-to-outside as is typical for gravity-flow conditions.

To obtain useful products, it is usually critical to use very small fibers to hold particulate ingredients. This avoids the need for thermoplastic particulate binders as in carbon block products. Such fibers can be from cellulose where they are naturally hydrophilic. If the cellulose has been fibrillated to an average fiber diameter of 200 nanometers for example, having a Canadian Standard Freeness (CSF) of less than 50, then a modest percentage of such fibers can retain a high percentage of finely divided solids. It is common for 10-20% by weight of such nanofibers to retain 70% by weight of 10-micron particulate ingredients.

It is also critical to point out that this accretive process allows the formation of products with enhanced surface area, but with wall thicknesses that cannot be mechanically pleated. For example, it is increasingly difficult or impossible to sharply pleat filter papers that are greater than 1.2 mm in thickness. In most cases, filter paper that is 1.5 mm in thickness is used in flat-sheet applications because it cannot be folded without the formation of cracks and defects. However, the accretion process permits the production of complex shapes such as shown in FIGS. 2 and 3 where the wall thickness can exceed that normally permitted during conventional production of folded filter paper. It has been found that such thick-walled structures can provide all of the target performance because the adsorption of a contaminant can be efficiently executed in this structure. In most cases, the accretive wall thickness is in the range of 1.2 to 1.7 mm. It should be noted that although the structures produced by the current process can be referred to as “pleated”, they are not the product of mechanical folding and “pleated” only means that the structure might have undulating surfaces produced without undue stress by formation on a suitable mold.

In another aspect of this disclosure, a relatively thick sheet of fibrillated paper (e.g., on the order of 1.2 mm to 1.7 mm thick), which as mentioned would be prone to cracking if pleated or folded while dry, is wetted sufficiently to render the sheet flexible and alleviate the risk of cracking. The flexible sheet then is pressed into a roughly conical filter article, possibly with pleats or undulations or indentations or other structure to enhance flow area. The pressed filter article then is heated to dry the paper while curing a binder that will stiffen the pressed filter article and impart wet strength adequate to support use of the pressed filter article in a gravity-flow filtration apparatus. The open end of the pressed filter article then may be capped as described elsewhere in this disclosure.

In the prior art, the majority of the filters are produced with a relatively thick wall of 10-20 mm thickness and are cylindrical in shape. In many cases, the fibers are not fibrillated and cannot be used to retain fine particulate active particles. It is the purpose of the current disclosure to produce non-cylindrical structures with relatively thin walls in the 1 to 2.5 mm thickness range and preferably in the 1.2 to 1.7 mm thickness range and capable of retaining extremely fine particulate ingredients without the use of a thermoplastic or thermoset binder. To produce such thin walls and retain such fine particles, we utilize nanofibers at 10-30% by weight of the solid ingredients of the slurry and preferably in the 10-20% range. Such nanofibers are usually produced by fibrillation of cut staple fibers subjected to refining or beating.

It is a further goal of the current disclosure to mold filters at exceptionally high speed with production cycle times less than 60 seconds and optimally less than 30 seconds. It is also the purpose of the current disclosure to permit the production of a very large number of filters during each production cycle and often exceeding 100 filters in each production cycle.

It is also the purpose of the current disclosure to create filter formulations routinely consisting of 50-80% particulate ingredient and only 20-50% fiber content. The fine particulate ingredients can include activated carbon, a wide variety of materials used to provide toxic metals adsorption, such as alumina-silicates, titanium silicates, hydroxyapatites, zeolites, smectite clays, iron oxides, aluminas, ion-exchange resins, and chemical treatments to provide enhanced nano-particulate interception such as positively charged polymers or lower molecular weight amines. The structure can also be treated with chemicals to provide enhanced microbiological control and such chemicals can be attached to the fiber and particulate ingredients through electrostatic, covalent, or other bonds.

It is another goal of the current disclosure to obtain pore structures with mean flow path (MFP) of less than 5 microns and preferably less than 2 microns.

It is another goal of the current disclosure to obtain filter elements that flow at greater than 100 ml/minute when operating at pressures as low as 6″ W.C. as measured from the top of the filter.

It is another goal of the current disclosure to create filter elements that provide greater than 99.9999% interception of bacteria such as Brevendimonas diminuta or Escherichia coli. It is another goal of the disclosure to provide greater than 99.95% interception of oocysts under NSF Standard 53. It is another goal of the disclosure to provide greater than 99.99% interception of MS-2 bacteriophage virus particles.

It is a further goal of the current disclosure to provide filter elements that can intercept nano-size lead orthophosphate particles, PFAS chemicals, chlorine, chloramine, sulfides, mercury, cadmium and lead at both high- and low-pH, and myriad toxic organic chemicals (VOCs and TTHMs as well as emerging chemical threats that are listed in NSF Standard 401 and are industrial chemicals, pesticides, herbicides and pharmaceuticals). Such adsorptive interception of these contaminants is made possible because the current disclosure permits the use of adsorptive particles smaller than 20 microns in diameter and generally less than 12 microns in diameter and even a high volume of particles 1-10 microns in diameter. The use of such small particles collapses the mass transfer zone of the adsorptive process into a space of less than 0.5 mm thickness and permits miniaturization of the filter element and a large reduction in production costs.

It is a further goal of the current disclosure to provide enhanced dirt holding capacity through the formation of a graded-density structure. The filters often have inside-to-outside flow direction and would be molded so that the mold is a series of porous cavities rather than the more typical molds consisting of one or more mandrels where slurry is deposited on the surface. Instead, our proposed mold consists of a series of porous cups leading to the outer surface of the molded item retaining the porous mold surface character.

It is a further goal of the current disclosure that the filter element is naturally hydrophilic such that flow commences spontaneously when the filter is used under gravity-flow conditions with an applied pressure of 6″ W.C. above the filter element and the filter does not need to be pre-wetted or “primed” using pressurized water.

It is a goal of the current disclosure to provide a filter medium that weighs generally less than 20 grams and usually about 12 grams and fits within legacy filter systems such as common carafe filter and dispenser systems such as those manufactured by companies such as PUR/Helen of Troy or Brita/Clorox. Even though the weight is extremely modest, the filters will provide the full spectrum of health and performance claims.

It is a goal of the current disclosure that the production process and tooling supports the production of filter elements with enhanced surface area so that they present a large cross-sectional flow area without the need to carry out traditional mechanical pleating or folding, the use of supporting scrims, or maintaining pleat spacing with flow netting. Instead, the walls of the filter are sufficient to retain a rigid shape even when wet and to emerge from the slurry molding process with the high surface area configuration already provided. Such rigidity allows for the elimination of a supporting core or cage to provide mechanical support to the filter.

It is another goal of the current disclosure to create a filter element that requires only a single end cap and only a single sealing surface rather than traditional filters that are end capped on both ends of the filter. In this case, the current disclosure has the topology of a cup where the open surface of the cup requires a seal, but the remainder of the cup is a continuous surface and requires no additional seal or cover and where this opposing surface is composed of the filter medium and contributes to the operation of the filter.

### BRIEF DESCRIPTION OF THE DRAWINGS

FIG. 1 is a simple cone-shaped filter element designed to fit legacy gravity-flow water filter systems.

FIG. 2 is a more complex structure with enhanced surface area to support enhanced flow and dirt holding capacity but also configured to fit legacy water filter systems.

FIG. 3 is an alternative geometry of a cone with an internal reverse cone that work together to provide enhanced flow and filter life.

FIG. 4 is a block diagram of an example slurry molding process according to an aspect of the current disclosure.

### DETAILED DESCRIPTION

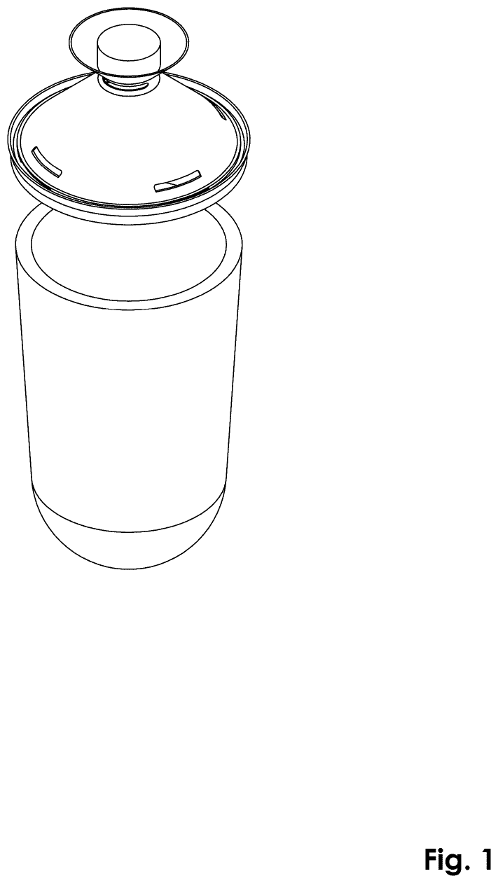

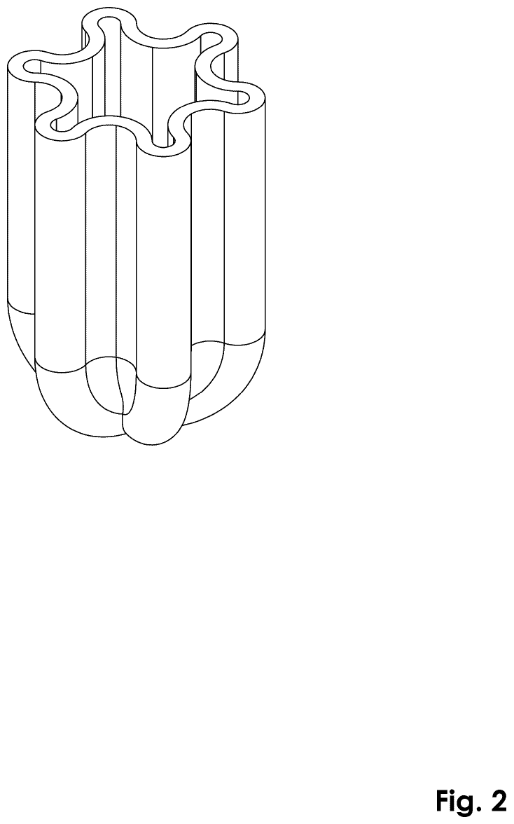

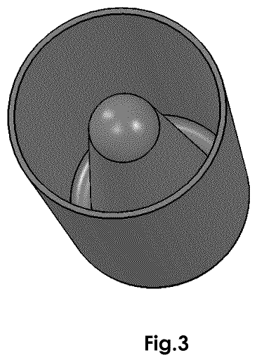

Because the majority of legacy filters are designed to flow from the inside to the outside of the filter and because it is desirable to present a smooth and dense structure toward the outside of such a filter, the accretion process is preferably arranged to form a topological cup-shaped structure by casting the fluid slurry containing fiber and particles into a cup-shaped cavity rather than being formed on an upright mandrel as is more common in the prior art. In addition, the current approach produces a relatively rigid thin-walled structure with a single open end rather than the more common thick-walled cylindrical structure of the prior art with a double open-ended (DOE) structure. FIG. 1 is an example of a simple cup-shaped filter element. FIG. 2 shows a more complex cup-shaped structure where the walls of the filter have been so formed as to provide undulations (folds or pleats) that enhance the cross-sectional flow area of the filter and also permit the filter to fit around projections and obstructions found in some legacy filter systems. FIG. 3 is another alternative means of obtaining additional surface for the filter and consists of casting an outer cone containing an inner and inverted cone. The larger surface area not only enhances the flow rate through the filter, but also provides enhanced surface to retain dirt—leading to enhanced filter life prior to severe clogging.

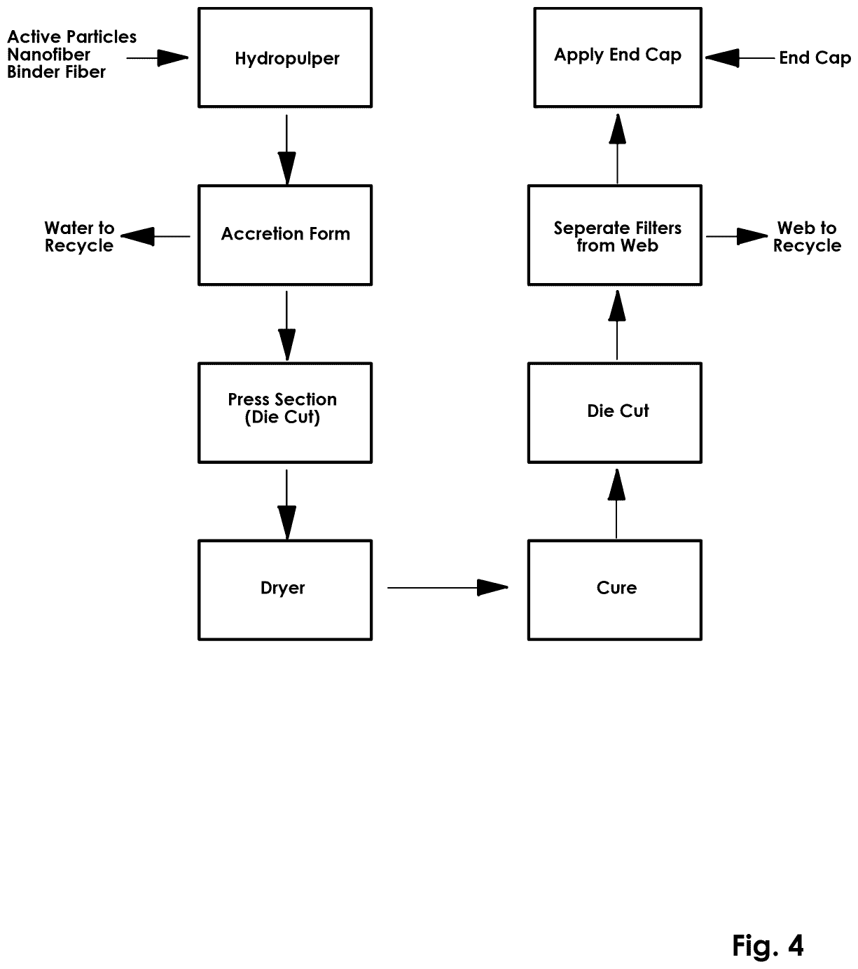

To produce the type of product shown in FIGS. 1-3, we can use a process similar to that shown in FIG. 4.

HYDROPULPING: In this process, the solid ingredients and any chemicals required to obtain enhanced filter performance or enhanced processing can be loaded with water into a hydropulper used to disperse and suspend the ingredients.

MOLDING: The resulting suspension (slurry) can then be sent to a molding machine where a porous mold is submerged into the circulating slurry within a molding tank and the solid ingredients are adhered to a mold to form the required shape. A vacuum is applied to the mold to draw the slurry onto the walls of the mold, where the solid ingredients accumulate while water is permitted to pass through the porous mold walls and is ejected to a “white water” tank. A male or female mold may be used. For a male mold, the vacuum suction is centrally applied and the slurry is drawn onto external surfaces of the mold. For a female mold, the vacuum suction is peripherally applied and the slurry is drawn into internal surfaces of the mold. The mold is eventually pulled from the slurry and excess slurry is either vacuumed onto the surface of the molded article or allowed to drain back into the molding tank. Excess moisture is removed from the molded product as much as practical by continuing to apply vacuum within the permitted molding cycle.

PRESSING: The dewatered molded part, still wet and having only a modest capacity to retain its shape, can then be moved to a pressing station, is then potentially subjected to supplemental pressure forming. This pressing operation can be used to further dewater the molded article and consists of a porous mold with both positive and negative compression structures meant to bring the molded article to its final density and shape. In most cases, this press section provides the means to vacuum additional water from the molded article while it is held under compression. As water is further withdrawn, the strength of the molded article increases. In most cases, this compression step only involves modest applied pressure such that the porosity and permeability of the filter are retained, but the pore structure can be adjusted to a specific target, generally displaying a MFP of less than 5 microns and preferably less than 2 microns when measured using a capillary porometer.

DRYING: In some cases, the production machine can include a third station where the dewatered and compressed article can be further subjected to heat to provide additional dewatering and drying of the molded article. In this case, the molded article can be loaded into a heated cavity with the shape of the molded article and vacuum, hot air, or heat from this heating station can be applied to drive the majority of the remaining moisture out of the molded article.

CURING: In many cases, one of the ingredients within the filter is a permanent wet strength agent that imparts enhanced rigidity and strength to the molded article even when re-wetted. This can be achieved using either traditional wet strength agents used in the paper industry or using binder fibers such as bicomponent fibers consisting of a sheath and core structure wherein the core is a high melting point polymer such as polypropylene or polyester and the sheath is composed of a lower melting point polymer such as polyethylene or co-polyester. Most of these wet strength agents require some degree of heat curing to activate their bonding and this can either be accomplished within the dryer outlined above or within a separate heater or oven. Such an oven can consist of a belt oven that moves the molded article through a heated space sufficient to cause the molded article to obtain a high degree of permanent wet strength.

DIE CUTTING AND WEB SEPARATION: In some cases, the individual filters are molded while attached to a common supporting web. For example, the mold might consist of an array of seven filters×5 filters for a total of 35 filters held together by a thin supporting web. Once fully dried and cured, this array can be loaded into a suitable die cutting machine and the individual filters can be separated from the supporting wet in a manner similar to how a product is separated from a supporting web in a traditional plastic thermoforming process. The individual filters can then be held in a vacuum fixture while the supporting web is stripped away. The filters, held in a fixture can then move immediately to the end capping process.

An alternative is to mold the filter elements without a supporting web and where they are individual and separate. This is arranged by having the original mold composed of forming sections with impermeable material located between the individual molding locations.

END CAP PROCESS: The most common means to apply a plastic end cap to the filter open end is either through the use of hot melt or fusion welding. When using hot melt, the end cap is so designed to receive a liquid hot melt on its inner surface and the filter is pressed into a circular bead of this liquid hot melt. In some cases, the hot melt can be replaced through the use of plastisol, urethane, polymer foams and other materials. In some cases, such as when using plastisol, there is no plastic end cap, and the plastisol is directly molded into the desired final shape of the end cap. Another method can be fusion welding where the surface of the end cap is exposed to heat, often through the application of infrared radiation applied to a specific region of the end cap, to cause a portion of the end cap surface to soften and/or melt. The filter can then be pressed directly into this molten surface to form the required seal. There are other means to apply a closure to the open end of the filter and such enclosure can provide a variety of precision sealing surfaces ranging from O-ring, elastomeric seals, and plastic reflex seals. All of these methods can be applied to the current disclosure.

Once the filter elements are end capped, they can be passed through conventional packaging and made ready for use by the consumer.

The slurry molded filters can also consist of a flat-sheet design where said flat sheet can include a flat surface around its periphery to permit the formation of a seal upon this flat surface while potentially including undulations inside of this periphery that serve to provide enhanced surface area for improved flow, dirt holding capacity, and to hold a larger amount of active ingredients. The “flat-sheet” designs are usually circular so that it can be engaged by a knife edge seal within a housing that screws together. However, in some cases, the design can be rectangular or square to fit into a housing that provides means to compress the edge of the filter medium to form a seal.

The undulations within this type of flat-sheet filter serve the same purpose as pleats in air and water filters but are not produced by folding, but are directly formed by molding the filter medium into this shape. This permits the filter medium to be relatively thick without experiencing the excessive stresses created during the pleating process that would lead to cracks and defects when attempting to fold an excessively thick and stiff filter medium. In some cases, the product can consist of a filter medium that has undulations throughout the entire surface. This effectively can be used as an axial filter or be used as a radial filter when the paper is rolled into a cylinder and the opposing edges are sealed using hot melt, ultrasonic welding, or other means. The resulting radial-flow filter can be end capped by various means well established in the prior art to complete the construction of the filter. In the case of an axial flow filter, the filter medium can be edge sealed with hot melt or a liquid polymer in a process called band sealing. Such filters are routinely used in automotive applications for cabin air filtration or as engine air filters.

### EXAMPLES

The following are non-limiting examples of systems and processes that can be made using the disclosure herein. As understood by a person having ordinary skill in the art, the figures provided herein may be modified to suit well-understood needs.

### Example 1

A slurry is produced from a blend of the following ingredients:
1. 35% by weight base carbon. 20 micron average particle size (>96% smaller than 325 mesh-44 micron), BET surface area of 1,100 sq.meters/gram coconut-shell activated carbon.
2. 15% by weight catalytic carbon, 14 micron average particle size, BET surface area of >1,000 sq.meters/gram wood-based activated carbon.
3. 10% by weight bicomponent fiber, 1.5 denier fiber diameter×6 mm length stable fiber, polypropylene core and polyethylene sheath.
4. 20% by weight fibrillated cellulose fiber, average fiber diameter 200 nanometers and average estimated length 1-2 mm.
5. 20% by weight metals adsorbent of 5-micron average particle diameter, alumina-silicate zeolite.

These ingredients are dispersed in a hydropulper to produce a slurry at 1% solids concentration. The slurry is poured into a 3-D printed cup-shaped mold of approximately 2″ diameter at the base, 3″ height, with a 3-degree taper with rounded nose. The mold is produced with a close-packed hexagonal array of small 0.5 mm diameter holes uniformly distributed throughout the surface of the mold. A vacuum is applied to the exterior of the mold and excess water is drawn through the cup-shaped mold while the solid ingredients are deposited on the inner surface of the cup-shaped mold. Once a suitable thickness of solid ingredients (1.5 mm) has accumulated on the inner surface of the mold, the mold is moved to a warm (70 C) oven and the material is dried overnight. The molded article is then easily ejected from the mold and placed in a second oven for 30minutes at 145 C to cause the bicomponent fibers to form high wet strength. The resulting molded filter element is end capped using hot melt and demonstrates a flow of approximately 200 ml/minute at an applied pressure of 6″ W.C. above the top of the molded article, a mean flow path of 2 microns, and a weight of 8 grams.

### Example 2

The experiment outlined in Example 1 is repeated but a second 3-D printed perforated cone having reduced dimensions compared to the mold used to create the molded article is used to compress the wet contents of the mold after the solids have been deposited onto the surface of the mold. This light compression of only about 10 psid is used to produce a smooth and consolidated inner surface to the molded article without destroying the desired gradient density of the product. The flow rate is approximately 150 ml/minute at an applied pressure of 6″ W.C. above the top of the molded article and the mean flow path is 1.4 microns.

1. A gravity-flow and hydrophilic water filter, comprising a water filter medium that has:
a thickness of 1 to 2.5 mm;
50-90% particulate ingredient and 10-50% fiber content; and
pore structures with mean flow path (MFP) of less than 5 microns.

2. The water filter of claim 1, wherein the water filter medium is made from a slurry having:
carbon 20-70% by weight;
catalytic carbon at 0-25% by weight;
wet strength additive at 0-20% by weight;
nanofibers at 5-30% by weight; and
metals adsorbent at 5-30% by weight.

3. The water filter of claim 1, wherein the water filter medium does not include a particulate or liquid thermoplastic or thermoset binder.

4. The water filter of claim 1, wherein the pore structures have a MFP of less than 2 microns.

5. The water filter of claim 1, wherein the water filter medium intercepts at least one of the following: nano-size lead orthophosphate particles, PFAS chemicals, chlorine, chloramine, sulfides, mercury, and lead at both high- and low-pH, toxic organic chemicals, or microbiological contaminants such as viruses, bacteria and oocysts.

6. The water filter of claim 1, having adsorptive particles less than 20 microns in diameter.

7. The water filter of claim 1, having adsorptive particles less than 12 microns in diameter.

8. The water filter of claim 1, having an adsorptive process mass transfer zone of less than 0.5 mm thickness.

9. The water filter of claim 1, having a graded-density structure providing enhanced dirt holding capacity.

10. The water filter of claim 1, having a first layer that is more porous than a second layer.

11. The water filter of claim 1, wherein the water filter medium is naturally hydrophilic such that flow commences spontaneously when the filter is used under gravity-flow conditions with an applied pressure of at least 6″ W.C.

12. The water filter of claim 1, wherein the wet strength adhesive comprises a bicomponent fiber.

13. The water filter of claim 1, adapted to fit within legacy filter systems such as carafe filter and dispenser systems.

14. The water filter of claim 1, wherein walls of the filter are sufficient to retain a rigid shape even when wet.

15. The water filter of claim 1, wherein the water filter has only a single end cap and only a single sealing surface.

16. The water filter of claim 1, wherein the water filter has a flat-sheet edge design to facilitate forming a seal.

17. The water filter of claim 16, wherein the flat sheet has a flat surface around its periphery to permit the formation of a seal upon this flat surface.

18. The water filter of claim 17, wherein the sheet or molded shape has a flat periphery and includes undulations and other non-flat structures inside of the periphery that serve to provide enhanced surface area for improved flow, dirt holding capacity, and to hold a larger amount of active ingredients.

19. A water filtration system, comprising:
a decanter;
a water filter formed from a filter medium with a closed end, an open end, an end cap at the open end, and walls of 1 to 2.5 mm thickness;
wherein the filter medium has:
50-90% particulate ingredient and 10-50% fiber content; and
a pore structure with mean flow path (MFP) of less than 5 microns.

20. The water filtration system of claim 19, wherein the water filter is made from a slurry having:
carbon 25-80% by weight where 0-25% by weight is a catalytic carbon;
wet strength additive at 0-20% by weight;
nanofibers at 5-30% by weight; and
metal adsorbent at 5-30% by weight.
